(19) United States
(12) Patent Application Publication
(10) Pub. No.: US 2014/0072671 A1
(43) Pub. Date: Mar. 13, 2014

(54) MULTI-COMPONENT ORAL DELIVERY SYSTEMS AND USES THEREOF

(71) Applicant: ADAM AUERBACH, Madison, WI (US)

(72) Inventor: ADAM AUERBACH, Madison, WI (US)

(21) Appl. No.: 13/929,720

(22) Filed: Jun. 27, 2013

Related U.S. Application Data
(60) Provisional application No. 61/666,117, filed on Jun. 29, 2012.

(51) Int. Cl. A23L 1/29

(52) U.S. Cl. CPC A23L 1/296
USPC 426/72; 426/541; 426/74

(57) ABSTRACT

The invention relates to multi-component oral delivery systems for use before and/or with physical activity. The invention also includes methods of making and using such multi-component oral delivery systems.

### CROSS-REFERENCE TO RELATED APPLICATIONS

This application claims the benefit of U.S. Provisional Application No. 61/666,117, filed Jun. 29, 2012, the entire contents of which are incorporated by reference herein.

### FIELD OF THE INVENTION

The invention relates to multi-component oral delivery system compositions, such as capsules and tablets, methods related to manufacturing and uses of the multi-component oral delivery systems, and kits comprising multi-component oral delivery systems.

### BACKGROUND OF THE INVENTION

Supplements, such as protein powders and sports drinks, are widely available and used by subjects performing physical activities, such as casual and professional athletes, to replenish nutrients and energy stores used up during the physical activity.

### SUMMARY OF INVENTION

Exercise and other physical activities take a toll on one's body due to the requirements of energy and nutrients during such activities. Athletes often take supplements in order to replenish the lost energy and nutrients. The supplements that exist for athletes, for example protein powders and sports drinks, do not address a body's needs during different stages of exercise and are often taken after exercise when depletion of energy and nutrients has already occurred.

The invention provided herein relates, at least in part, to supplements that can deliver vitamins and other nutrients to the body before, during, and/or after exercise in a targeted manner to address the physiological needs during different stages of physical activity such as exercise. Such supplements can be used to maximize performance and/or increase the benefits of exercise. The invention provides multi-component oral delivery systems, and in some aspects multi-component oral delivery systems for administration to subjects such as athletes. The invention also includes methods of making and using such multi-component oral delivery systems. An important feature of this invention is the delivery of components with the correct timing and/or absorption pattern to benefit a subject that is undergoing or will undergo physical activity (e.g., exercise).

In some aspects, the invention provides a multi-component oral delivery system comprising: a) a first composition comprising at least one antioxidant, wherein the first composition is adapted to release the at least one antioxidant in the oral cavity of a subject; b) a second composition comprising at least one electrolyte, wherein the second composition is adapted to release the at least one electrolyte in the stomach of the subject; and c) a third composition comprising at least one vitamin and/or at least one amino acid, wherein the third composition is adapted to release the at least one vitamin and/or at least one amino acid in the intestine of the subject. In some embodiments, the multi-component oral delivery system protects against muscle fatigue, combats harmful byproducts, maintains energy reserves, releases electrolytes to prevent dehydration, rebuilds muscle tissue and/or relieves pain. Preferably, in some embodiments, the first composition and/or component or components thereof protects against muscle fatigue and/or combats harmful byproducts; the second composition and/or component or components thereof maintains energy reserves and/or releases electrolytes to prevent dehydration; and/or the third composition and/or component or components thereof rebuilds muscle tissue and/or relieves pain. In some embodiments, the subject is an animal. In another embodiment, the subject is a human. In some embodiments, the subject is an athlete.

In some embodiments, the at least one antioxidant is Vitamin A, Vitamin C, Vitamin E, glutathione, a proanthocyanidin, a curcumin, a resveratrol, a flavonoid, Coenzyme Q10, Selenium, Zinc, epigallocatechin gallate, a withanolide, a polyphenol or a carotenoid. In another embodiment, the at least one electrolyte is chloride, potassium, sodium, magnesium, calcium, bicarbonate, sulfate, hydrogen phosphate, phosphate, or a salt thereof. In some embodiments, the at least one vitamin is Vitamin A, a B vitamin, Vitamin C, Vitamin D, Vitamin E, Vitamin K, Vitamin M, or a vitamer thereof. In some embodiments, the at least one vitamin is a B vitamin. In some embodiments, the B vitamin is B1, B2, B3, B5, B6, B7, B9, or B12. In another embodiment, the at least one amino acid is selected from the group consisting of: alanine, arginine, aspartic acid, glutamic acid, glycine, histidine, isoleucine, leucine, lysine, methionine, phenylalanine, proline, serine, threonine, tyrosine, valine, tryptophan, cysteine, and glutamine.

In some embodiments, the second composition further comprises at least one vitamin or at least one mineral. In another embodiment, the at least one vitamin of the second composition is Vitamin A, a B vitamin, Vitamin C, Vitamin D, Vitamin E, or Vitamin K, or a vitamer thereof. In some embodiments, the at least one mineral of the second composition is Boron, Calcium, Chlorine, Chromium, Copper, Fluorine, Iodine, Iron, Magnesium, Manganese, Molybdenum, Nickel, Phosphorus, Potassium, Selenium, Sodium, Vanadium, Zinc or a salt form thereof. In another embodiment, the third composition further comprises glutathione.

In a further embodiment, the first composition comprises Vitamin A, Vitamin C, and Vitamin E; the second composition comprises an electrolyte; and the third composition comprises glutathione, an amino acid, Vitamin B1, Vitamin B6, and Vitamin B12. In another embodiment, Vitamin A is present in an amount of 500 micrograms to 3000 micrograms, Vitamin C is present in an amount of 50 milligrams to 2000 milligrams, Vitamin E is present in an amount of 10 milligrams to 1000 milligrams, Vitamin B1 is present in an amount of 1 milligram to 100 milligrams, Vitamin B6 is present in an amount of 1 milligram to 100 milligrams, and Vitamin B 12 is present in an amount of 2 micrograms to 2000 micrograms, and glutathione is present in an amount of 50 mg to 600 mg.

In some embodiments, the first composition further comprises a flavoring agent. In another embodiment, the flavoring agent can no longer be tasted by the subject after release of the at least one antioxidant in the oral cavity.

In some embodiments, the first composition is coated with an inert material. In another embodiment, the inert material of the first composition comprises an inert polymer. In some embodiments, the inert polymer of the first composition comprises cellulose. In another embodiment, the inert material of the first composition is present in an amount effective to provide lag-time between delivery of the first composition to the oral cavity and the subsequent delivery of the second composition into the stomach. In some embodiments, the second composition is coated with an inert material. In another embodiment, the inert material of the second composition comprises an inert polymer. In some embodiments, the inert material or inert polymer of the second composition comprises Vitamin M.

In some embodiments, the third composition is coated with an enteric coating. In some embodiments, the enteric coating comprises phthalates, methyl acrylate-methacrylic acid copolymers, cellulose acetate succinate (hypromellose acetate succinate), polyvinyl acetate phthalate (PVAP), sodium alginate and/or stearic acid. In another embodiment, the enteric coating comprises cellulose acetate phthalate. In some embodiments, the enteric coating is present in amount effective to provide lag-time between delivery of the second composition into the stomach and the subsequent delivery of the third composition into the intestine.

In some embodiments, the multi-component oral delivery system comprises a first layer, a second layer and a third layer, wherein the first layer comprises the first composition, the second layer comprises the second composition and the third layer comprises the third composition. In some embodiments, the multi-component oral delivery system is a tablet or a capsule.

In another aspect, the invention provides a method comprising administering the multi-component oral delivery system described above to a subject. In some embodiments, the subject being administered the multi-component oral delivery system is an animal. In some embodiments, the subject is a human. In some embodiments, the subject is an athlete. In some embodiments, the method comprises administering the multi-component oral delivery system to the subject before physical activity. In some embodiments, the multi-component oral delivery system is administered to the subject 30 minutes before physical activity. In some embodiments, the multi-component oral delivery system is administered to the subject 1 hour before physical activity. In some embodiments, physical activity is exercise.

In another aspect, the invention provides a kit, comprising: a) any of the multi-component oral delivery systems described above; and b) a storage container. In some embodiments, the kit further comprises c) instructions. In some embodiments, the instructions indicate that a subject should swallow the multi-component oral delivery system after dissolution of the first composition in the oral cavity. In some embodiments, the instructions indicate that a subject should swallow the multi-component oral delivery system after the flavoring agent can no longer be tasted.

In yet another aspect, the invention provides a method of manufacturing a multi-component oral delivery system, comprising: a) preparing or obtaining a first composition comprising at least one antioxidant, wherein the first composition is adapted to release the at least one antioxidant in the oral cavity of a subject; b) preparing or obtaining a second composition comprising at least one electrolyte, wherein the second composition is adapted to release the at least one electrolyte in the stomach of the subject; c) preparing or obtaining a third composition comprising at least one vitamin and/or at least one amino acid, wherein the third composition is adapted to release the at least one vitamin and/or at least one amino acid in the intestine of the subject; and d) combining the first, second, and third compositions to produce a multi-component delivery system. In some embodiments, d) further comprises compressing the first, second, and third compositions. In some embodiments, the multi-component delivery system is a tablet or capsule.

In another aspect, the invention provides a method of manufacturing a multi-component oral delivery system, comprising: a) preparing or obtaining a first composition comprising at least one antioxidant, wherein the first composition is adapted to release the at least one antioxidant in the oral cavity of a subject; b) compressing the first composition to form a first layer; c) preparing or obtaining a second composition comprising at least one electrolyte, wherein the second composition is adapted to release the at least one electrolyte in the stomach of the subject; d) compressing the second composition to form a second layer; e) preparing or obtaining a third composition comprising at least one vitamin and/or at least one amino acid, wherein the third composition is adapted to release the at least one vitamin and/or at least one amino acid in the intestine of the subject; f) compressing the third composition to form a third layer; and g) compressing the first, second, and third layers to provide a multi-component oral delivery system.

In another aspect the invention provides a method of manufacturing a multi-component oral delivery system, comprising: a) preparing or obtaining a first dry composition comprising at least one antioxidant, wherein the first dry composition is adapted to release in the oral cavity of a subject; b) wet massing the first dry composition to produce a first wet mass; c) extruding the first wet mass to produce a first extruded wet mass; d) spheronizing the first extruded wet mass to obtain a first set of wet spheroids; e) drying the first set of wet spheroids to obtain a first set of spheroids; f) preparing or obtaining a second dry composition comprising at least one electrolyte, wherein the second dry composition is adapted to release the at least one electrolyte in the stomach of the subject; g) wet massing the second dry composition to produce a second wet mass; h) extruding the second wet mass to produce a second extruded wet mass; i) spheronizing the second extruded wet mass to obtain a second set of wet spheroids; j) drying the second set of wet spheroids to obtain a second set of spheroids; k) preparing or obtaining a third dry composition comprising at least one vitamin and/or at least one amino acid, wherein the third dry composition is adapted to release the at least one vitamin and/or at least one amino acid in the intestine of the subject; l) wet massing the third dry composition to produce a third wet mass; m) extruding the third wet mass to produce a third extruded wet mass; n) spheronizing the third extruded wet mass to obtain a third set of wet spheroids; o) drying the third set of wet spheroids to obtain a third set of spheroids; p) combining the first, second, and third set of spheroids to produce a multi-component oral delivery system. In some embodiments, the method further comprises combining the first, second, and third set of spheroids in a capsule to produce the multi-component oral delivery system.

In yet another aspect, the invention provides a method of manufacturing a multi-component oral delivery system, comprising: a) preparing or obtaining a first dry composition comprising at least one antioxidant; b) wet massing the first dry composition to produce a first wet mass; c) extruding the first wet mass to produce a first extruded wet mass; d) spheronizing the first extruded wet mass to obtain a first set of wet spheroids; e) drying the first set of wet spheroids to obtain a first set of spheroids; f) adapting the first set of spheroids to release the at least one antioxidant in the oral cavity of a subject; g) preparing or obtaining a second dry composition comprising at least one electrolyte; h) wet massing the second dry composition to produce a second wet mass; i) extruding the second wet mass to produce a second extruded wet mass; j) spheronizing the second extruded wet mass to obtain a second set of wet spheroids; k) drying the second set of wet spheroids to obtain a second set of spheroids; 1) adapting the second set of spheroids to release the at least one electrolyte in the stomach of the subject; m) preparing or obtaining a third dry composition comprising at least one vitamin and/or at least one amino acid; n) wet massing the third dry composition to produce a third wet mass; o) extruding the third wet mass to produce a third extruded wet mass; p) spheronizing the third extruded wet mass to obtain a third set of wet spheroids; q) drying the third set of wet spheroids to obtain a third set of spheroids; r) adapting the third set of spheroids to release the at least one vitamin and/or at least one amino acid in the intestine of the subject; and s) combining the first, second, and third set of spheroids to produce a multi-component oral delivery system. In some embodiments, the method further comprises combining the first, second, and third set of spheroids in a capsule to produce the multi-component oral delivery system.

In some embodiments of any of the methods of manufacturing mentioned above, the multi-component oral delivery system produced is any of the multi-component oral delivery systems described above.

Each of the limitations of the invention can encompass various embodiments of the invention. It is, therefore, anticipated that each of the limitations of the invention involving any one element or combination of elements can be included in each aspect of the invention.

### DETAILED DESCRIPTION OF INVENTION

Physical activity, e.g. exercise, is important for enhancing or maintaining physical fitness and overall health and wellness. Physical activities such as exercise are performed for various reasons including strengthening muscles and the cardiovascular system, honing athletic skills, and weight loss or maintenance. Frequent and regular physical exercise boosts the immune system, and helps prevent heart disease, cardiovascular disease, Type 2 diabetes and obesity. Physical activities such as exercise also improve mental health, help prevent depression, and help to promote or maintain positive self-esteem.

During physical activity, especially when performed for long periods of time or to a strenuous degree, several negative effects can result. For instance, muscle groups consume energy during physical activity through fat metabolism and conversion of glycogen into glucose. After prolonged or strenuous activity, glycogen stores become depleted, resulting in sudden fatigue and loss of energy sometimes referred to as “hitting the wall” (Kimber, N., Heigenhauser, G., Spriet, L., and Dyck, D. 2003. Skeletal muscle fat and carbohydrate metabolism during recovery from glycogen-depleting exercise in humans. The Journal of Physiology, 548 (Pt. 3), 919-927.). Physical activity, especially when undertaken for extended periods of time, can also alter the osmotic balance in a subject. Often, this is the result of the loss of electrolytes through sweat, increasing the risk of conditions such as exercise-associated hyponatraemia (Hew-Butler T. Arginine vasopressin, fluid balance and exercise: is exercise-associated hyponatraemia a disorder of arginine vasopressin secretion? Sports Med. 2010 Jun. 1; 40(6):459-79.).

Strenuous physical activity is also known to increase the production of reactive oxygen species (ROS) up to 20 fold above resting state, which increases the risk of oxidative stress and DNA damage (Power, S., Deruisseu, J., and Hamilton, K. Dietary Antioxidants and Exercise. Journal of Sports Sciences. 22.1 (2004): 81-94 and Balakrishnan S D, Anuradha C V. Exercise, depletion of antioxidants and antioxidant manipulation. Cell Biochem Funct. 1998 December; 16(4):269-75.). Additionally, blood obtained from athletes after performing intense exercise was found to have lipid peroxidation biomarkers at levels comparable to levels seen in heart attack patients (Caimi, Gregorio et al. Lipid peroxidation and total antioxidant status in unprofessional athletes before and after a cardiopulmonary test. Clinical Hemorhealogy and Microcirculation 43.3 (2009): 235-241.).

Following strenuous physical activity, recovery begins. Recovery involves multiple steps, such as glycogen resynthesis, rehydration, and rebuilding of muscle tissue. During recovery, muscle and joint pain is common. Traditional pain medications such as NSAIDS and opiates have been shown to be detrimental to the formation of new muscle tissue, hampering the progress of recovery after physical activity (Painkiller B's. Sports Medicine. Joe Weider's Muscle & Fitness. August 2003: 196. Academic OneFile.).

The negative effects of physical activity as outlined above, in particular depletion of glycogen stores, electrolyte depletion, production of ROS, and pain, may prevent a subject from undertaking physical activity with maximal performance or from gaining the full benefits of physical activity. Current supplements (e.g., powders, beverages, and tablets) provide nutrients and electrolytes to negate or alleviate some of these symptoms. However, a need exists for supplements that deliver vitamins, minerals and other components (e.g., electrolytes and antioxidants) with different stages of release at appropriate times and locations within a subject to prevent or alleviate a number of negative effects of physical activity.

Accordingly, aspects of the present invention provide a multi-component oral delivery system that is useful for administering various dosage levels of vitamins, minerals and/or other components (e.g., electrolytes and antioxidants) to a subject, such as a human. The multi-component oral delivery system of the present invention is especially useful for administering vitamins, minerals and/or other components (e.g., electrolytes and antioxidants) to a subject before physical activity.

### Multi-Component Oral Delivery System

In one aspect of the invention, the multi-component oral delivery system is a system adapted to deliver components (e.g., vitamins, minerals, antioxidants, amino acids, electrolytes) to desired locations within the body of a subject (e.g., oral cavity, stomach, and/or intestine). In some embodiments, a first composition comprising a component or components is adapted to release in the oral cavity, a second comprising a component or components is adapted to release in the stomach, and a third composition comprising a component or components are adapted to release in the intestine.

In some embodiments, the multi-component oral delivery system comprises layers, with each layer, at least part of which is adapted to release at a desired location within the body. In some embodiments, the multi-component oral delivery system comprises three layers. In some embodiments, at least part of the first layer is adapted to release in the oral cavity, at least part of the second layer is adapted to release in the stomach and at least part of the third layer is adapted to release in the intestine. In some embodiments, the multi-component oral delivery system comprises: a) at least one antioxidant that is released in the oral cavity of a subject; b) at least one electrolyte that is released in the stomach of the subject; and c) at least one vitamin and/or at least one amino acid that is/are released in the intestine of the subject. As used herein, “oral cavity” encompasses the mouth of a subject. As used herein, “stomach” encompasses the stomach alone or the stomach and duodenum of a subject. As used herein “intestine” encompasses the small intestine, the large intestine, or both, of a subject.

In some embodiments, the multi-component oral delivery system is a capsule or tablet, such as a multilayer capsule or tablet. In some embodiments, the multilayer capsule or tablet comprises three layers. In some embodiments, the multilayer capsule or tablet comprises: a) a layer adapted to release a component or components in the oral cavity; b) a layer adapted to release a component or components in the stomach; and c) a layer adapted to release a component or components in the intestine. In some embodiments, the multilayer capsule or tablet comprises: a) a first layer comprising at least one antioxidant; b) a second layer comprising at least one electrolyte; and c) a third layer comprising at least one vitamin and/or at least one amino acid. In some embodiments, each layer is a powder or compressed powder. In some embodiments, each layer is a gel. In some embodiments, each layer is a liquid. In some embodiments, the multilayer capsule or tablet may comprise powder layers and gel layers. In some embodiments, the multilayer capsule or tablet comprises powder layers and liquid layers. In some embodiments, the multilayer capsule or tablet comprises gel layers and liquid layers. In some embodiments, the layers are separated by at least one coating. In some embodiments the at least one coating is adapted to release or allows for the release of a component or components at a desired location. In some embodiments, the multilayer capsule or tablet comprises: a) a layer adapted to release a component or components in the oral cavity; b) a layer adapted to release a component or components in the stomach; and c) a layer adapted to release a component or components in the intestine. In embodiments, the layers are coated, and it is the coating that adapts the layer to release a component or components as desired. In embodiments, the layers are separated by at least one coating.

In some embodiments, the multi-component oral delivery system is a capsule comprising spheroids adapted to release in desired locations in the body. In some embodiments, the capsule comprises three sets of spheroids comprising: a) spheroids adapted to release in the oral cavity; b) spheroids adapted to release in the stomach; and c) spheroids adapted to release in the intestine. In some embodiments, the capsule coating is adapted to release the three sets of spheroids in the oral cavity. In some embodiment, the capsule comprises three sets of spheroids comprising: a) at least one antioxidant that is released in the oral cavity of a subject; b) at least one electrolyte that is released in the stomach of the subject; and c) at least one vitamin and/or at least one amino acid that is/are released in the intestine of the subject, respectively.

### Antioxidant

As described herein, an antioxidant refers to a molecule that inhibits the oxidation of other molecules. Examples of antioxidants include, but are not limited to, Vitamin A, Vitamin C, Vitamin E, glutathione, proanthocyanidins, curcumin, resveratrols, flavonoids, Coenzyme Q10, Selenium, Zinc, epigallocatechin gallate, withanolides, polyphenols or carotenoids (e.g., beta-carotene or lycopene). Antioxidants can be derived from natural sources such as plants (e.g., fruits, vegetables, herbs, or teas). Antioxidants can also be derived from non-natural sources, such as chemical synthesis.

### Electrolyte

As described herein, an electrolyte refers to an ion or to a compound or molecule that, when added to a liquid such as water, creates ions with a negative (anion) or positive (cation) charge. Examples of electrolytes include, but are not limited to, chloride, potassium, sodium, magnesium, calcium, bicarbonate, sulfate, hydrogen phosphate, phosphate, or a salt thereof.

### Vitamin and Vitamin Derivatives

As described herein, a vitamin is a compound required as a nutrient by a subject, e.g. a human. Examples of vitamins include, but are not limited to: Vitamin A, a B vitamin, Vitamin C, Vitamin D, Vitamin E, Vitamin K, and Vitamin M. In some embodiments, a vitamin is a vitamer. A vitamer of a particular vitamin is any of a number of chemical compounds, generally having a similar molecular structure, each of which shows vitamin-activity in a vitamin-deficient biological system. The amount of vitamins included within the multi-component oral delivery system may depend on the daily minimum recommended dose of the particular vitamin, which can be exceeded by on average 50-200%. In some embodiments, the amounts of vitamins may be 0-100% less than the daily recommended dose. In embodiments, the amounts of vitamins may be 50-100% less than the daily recommended dose. Examples of daily recommended doses and upper intake limits are shown in Table 1. It is to be understood that the amount of vitamins or vitamers used depends on the subject (e.g., the subject's age, gender, and health) and can differ from those provided in Table 1.

TABLE 1
Vitamin dietary allowances and upper limits based on FDA
recommendations.

| | | Recommended | | Upper | |
|---|---|---|---|---|---|
| | | Dietary | | Intake Level | |
| | | Allowance (per | | (per day, | |
| | | day, based on a | | based on a | |
| Vitamin | Examples of Vitamers | male 19-70) | | male 19-70) | |
| Vitamin A | Retinol, retinal, and four | 900 | μg | 3,000 | μg |
| | carotenoids: the carotenes | | | | |
| | alpha-carotene, beta- | | | | |
| | carotene, gamma-carotene; | | | | |
| | and the xanthophyll | | | | |
| | beta-cryptoxanthin | | | | |
| Vitamin B1 | Thiamine, thiamine | 1.2 | mg | N/D | |
| | pyrophosphate | | | | |
| Vitamin B2 | Riboflavin, flavin | 1.3 | mg | N/D | |
| | mononucleotide (FMN), | | | | |
| | flavin adenine | | | | |
| | dinucleotide (FAD) | | | | |
| Vitamin B3 | Niacin, niacinamide | 16.0 | mg | 35.0 | mg |
| Vitamin B5 | Pantothenic acid | 5.0 | mg | N/D | |
| Vitamin B6 | Pyridoxine, pyridoxamine, | 1.3-1.7 | mg | 100 | mg |
| | pyridoxal, pyridoxal | | | | |
| | 5-phosphate | | | | |
| Vitamin B7 | Biotin | 30.0 | μg | N/D | |
| Vitamin B9 | Folic acid, folinic acid, 5- | 400 | μg | 1,000 | μg |
| | Methyltetrahydrofolate | | | | |
| Vitamin B12 | Cyanocobalamin, | 2.4 | μg | N/D | |
| | hydroxocobalamin, | | | | |
| | methylcobalamin, | | | | |
| | adenosylcobalamin | | | | |
| Vitamin C | Ascorbic acid, calcium | 90.0 | mg | 2,000 | mg |
| | ascorbate, sodium | | | | |
| | ascorbate, other salts | | | | |
| | of ascorbic acid | | | | |
| Vitamin D | ergocalciferol, | 5.0 μg-10 μg | | 50 | μg |
| | cholecalciferol | | | | |
| Vitamin E | Tocopherols (d-alpha, | 15.0 | mg | 1,000 | mg |
| | d-beta, d-gamma, and | | | | |
| | d-delta-tocopherol), | | | | |
| | tocotrienols | | | | |
| Vitamin K | Phylloquinone, | 120 | μg | N/D | |
| | menaquinones, | | | | |
| | menadiones | | | | |
| Vitamin M | Folate | 400 | μg | 1000 | μg |

In some embodiments, the amount of a vitamin in the multi-component oral delivery systems provided is the recommended dietary allowance for that vitamin as described in Table 1. In some embodiments, the amount of a vitamin in the multi-component oral delivery systems provided is the upper intake level for that vitamin as described in Table 1. In some embodiments, the amount of a vitamin in the multi-component oral delivery systems provided is between the recommended dietary allowance and the upper intake level for that vitamin as described in Table 1. In some embodiments, the amount of a vitamin in the multi-component oral delivery systems provided is below the recommended dietary allowance as described in Table 1.

In some embodiments, Vitamin A or a vitamer thereof is present in an amount of 100 to 3000, 500 to 3000, 600 to 3000, 700 to 3000, 800 to 3000, 900 to 3000, 1000 to 3000, 1500 to 3000, 2000 to 3000, or 2500 to 3000 micrograms. In some embodiments, Vitamin B1 or a vitamer thereof is present in an amount of 0.1 to 100, 0.5 to 100, 1 to 100, 1.2 to 100, 2 to 100, 5 to 100, 10 to 100, 25 to 100, 50 to 100, or 75 to 100 milligrams. In some embodiments, Vitamin B2 or a vitamer thereof is present in an amount of 0.1 to 100, 0.5 to 100, 1 to 100, 1.3 to 100, 2 to 100, 5 to 100, 10 to 100, 25 to 100, 50 to 100, or 75 to 100 milligrams. In some embodiments, Vitamin B3 or a vitamer thereof is present in an amount of 1 to 35, 2 to 35, 5 to 35, 10 to 35, 15 to 35, 16 to 35, 20 to 35, or 25 to 35 milligrams. In some embodiments, Vitamin B6 or a vitamer thereof is present in an amount of 0.1 to 100, 0.5 to 100, 1 to 100, 1.3 to 100, 1.4 to 100, 1.5 to 100, 1.6 to 100, 1.7 to 100, 5 to 100, 10 to 100, 25 to 100, 50 to 100, or 75 to 100 milligrams. In some embodiments, Vitamin B7 or a vitamer thereof is present in an amount of 10 to 1000, 20 to 1000, 30 to 1000, 50 to 1000, 100 to 1000, 500 to 1000, or 750 to 1000 micrograms. In some embodiments, Vitamin B9 or a vitamer thereof is present in an amount of 100 to 1000, 200 to 1000, 300 to 1000, 400 to 1000, 500 to 1000, 600 to 1000, 700 to 1000, 800 to 1000, or 900 to 1000 micrograms. In some embodiments, Vitamin B12 or a vitamer thereof is present in an amount of 1 to 2000, 2 to 2000. 2.4 to 2000, 5 to 2000, 10 to 2000, 50 to 2000, 100 to 2000, 500 to 2000, 1000 to 2000, or 1500 to 2000 micrograms. In some embodiments, Vitamin C or a vitamer thereof is present in an amount of 10 to 2000, 50 to 2000, 90 to 2000, 100 to 2000, 500 to 2000, 1000 to 2000, or 1500 to 2000 milligrams. In some embodiments, Vitamin D or a vitamer thereof is present in an amount of 1 to 50, 5 to 50, 10 to 50, 20 to 50, 30 to 50 or 40 to 50 micrograms. In some embodiments, Vitamin E or a vitamer thereof is present in an amount of 1 to 1000, 5 to 1000, 10 to 1000, 15 to 1000, 20 to 1000, 50 to 1000, 100 to 1000, 250 to 1000, 500 to 1000, or 750 to 1000 milligrams. In some embodiments, Vitamin K or a vitamer thereof is present in an amount of 50 to 1000, 100 to 1000, 120 to 1000, 250 to 1000, 500 to 1000, or 750 to 1000 micrograms. In some embodiments, Vitamin M or a vitamer thereof is present in an amount of 100 to 1000, 200 to 1000, 300 to 1000, 400 to 1000, 500 to 1000, 600 to 1000, 700 to 1000, 800 to 1000, or 900 to 1000 micrograms.

In one embodiment, Vitamin A is present in an amount of 500 micrograms to 3000 micrograms, Vitamin C is present in an amount of 50 milligrams to 2000 milligrams, Vitamin E is present in an amount of 10 milligrams to 1000 milligrams, Vitamin B1 is present in an amount of 1 milligram to 100 milligrams, Vitamin B6 is present in an amount of 1 milligram to 100 milligrams, and Vitamin B 12 is present in an amount of 2 micrograms to 2000 micrograms.

### Amino Acids and Related Molecules

An amino acid is any molecule containing an amine group, a carboxylic acid group, and a side chain. An amino acid may be a standard or non-standard amino acid. Examples of standard amino acids include alanine, arginine, aspartic acid, glutamic acid, glycine, histidine, isoleucine, leucine, lysine, methionine, phenylalanine, proline, serine, threonine, tyrosine, valine, tryptophan, cysteine, and glutamine. Non-standard amino acids include alpha-aminoadipic acid, alpha-amino-N-butyric acid, beta-alanine, beta-amino-isobutyric acid, taurine, carnitine, citrulline, L-carnosine, GABA, hydroxyproline, 1-methylhistidine, 3-methylhistidine, lanthionine, N-Acetyl-L-Cysteine, 2-aminoisobutyric acid, dehydroalanine, ornithine, PABA, phosphoserine, phosphoethanolamine and gamma-aminobutyric acid. Amino acids may be used as single molecules, or may be linked together to form peptides, for example the tripeptide glutathione. In some embodiments, glutathione is present in an amount of 50 mg to 600 mg.

### Minerals

A mineral is any inorganic element that is useful for the functioning of a subject. Minerals include both macrominerals, microminerals, and trace minerals. Examples of minerals include, but are not limited to, Boron, Calcium, Chlorine, Chromium, Cobalt, Copper, Fluorine, Iodine, Iron, Magnesium, Manganese, Molybdenum, Nickel, Phosphorus, Potassium, Selenium, Sodium, Vanadium, Zinc and salt forms thereof suitable for consumption, e.g. carbonates, bicarbonates, phosphates, biphosphates, sulfates, bisulfates, chlorides, fluorides, citrates or lactates.

In some embodiments, the amount of a mineral in the multi-component oral delivery systems provided is the recommended dietary allowance for that mineral as described in Table 2. In some embodiments, the amount of a mineral in the multi-component oral delivery systems provided is the upper intake level for that mineral as described in Table 2. In some embodiments, the amount of a mineral in the multi-component oral delivery systems provided is between the recommended dietary allowance and the upper intake level for that mineral as described in Table 2. In some embodiments, the amount of a mineral in the multi-component oral delivery systems provided is below the recommended dietary allowance as described in Table 2. It is to be understood that the amount of minerals or salts thereof used depends on the subject (e.g., the subject's age, gender, and health) and can differ from those provided in Table 2.

TABLE 2
Mineral dietary allowances and upper limits based on FDA
recommendations. *Amount is adequate intake amount, as daily
allowance is not established.

| | Recommended Dietary | | Upper Intake | |
|---|---|---|---|---|
| | Allowance (per day, | | Level (per day, | |
| Mineral | based on a male 19-70) | | based on a male 19-70) | |
| Boron | <20 | mg | 20 | mg |
| Calcium | 1000 | mg | 2500 | mg |
| Chlorine | 2300 | mg | 3600 | mg |
| Chromium | 35 | micrograms* | N/D | |
| Copper | 900 | micrograms | 10 | mg |
| Fluorine | 4 | mg* | 10 | mg |
| Iodine | 150 | micrograms | 1100 | micrograms |
| Iron | 8 | mg | 45 | mg |
| Magnesium | 350 | mg | 400 | mg |
| Manganese | 2.3 | mg* | 11 | mg |
| Molybdenum | 45 | micrograms | 2000 | micrograms |
| Nickel | <1 | mg | 1 | mg |
| Phosphorus | 700 | mg | 4000 | mg |
| Potassium | 4700 | mg* | N/D | |
| Selenium | 55 | micrograms | 400 | micrograms |
| Sodium | 1500 | mg | 2300 | mg |
| Vanadium | <1.8 | mg | 1.8 | mg |
| Zinc | 11 | mg | 40 | mg |

In some embodiments, Boron or a salt thereof is present in an amount of 1 mg to 20 mg. In some embodiments, Calcium or a salt thereof is present in an amount of 500 mg to 2500 mg. In some embodiments, Chlorine or a salt thereof is present in an amount of 1000 mg to 3600 mg. In some embodiments, Chromium or a salt thereof is present in an amount of 15 micrograms to 100 micrograms. In some embodiments, Copper or a salt thereof is present in an amount of 500 micrograms to 10 milligrams. In some embodiments, Fluorine or a salt thereof is present in an amount of 2 mg to 10 mg. In some embodiments, Iodine or a salt thereof is present in an amount of 75 micrograms to 1100 micrograms. In some embodiments, Iron or a salt thereof is present in an amount of 4 mg to 45 mg. In some embodiments, Magnesium or a salt thereof is present in an amount of 150 mg to 400 mg. In some embodiments, Manganese or a salt thereof is present in an amount of 1 mg to 11 mg. In some embodiments, Molybdenum or a salt thereof is present in an amount of 20 micrograms to 2000 micrograms. In some embodiments, Nickel or a salt thereof is present in an amount of 0.1 mg to 1 mg. In some embodiments, Phosphorus or a salt thereof is present in an amount of 350 mg to 4000 mg. In some embodiments, Potassium or a salt thereof is present in an amount of 2500 mg to 10000 mg. In some embodiments, Selenium or a salt thereof is present in an amount of 25 micrograms to 400 micrograms. In some embodiments, Sodium or a salt thereof is present in an amount of 750 mg to 2300 mg. In some embodiments, Vanadium or a salt thereof is present in an amount of 0.1 mg to 1.8 mg. In some embodiments, Zinc or a salt thereof is present in an amount of 5 mg to 40 mg.

### Alkaloids

In some embodiments, any of the multi-component delivery systems provided can further comprise an alkaloid or alkaloid containing substance. In some embodiments, the alkaloid or alkaloid containing substance is caffeine, theobromine, or theophylline. In some embodiments, the alkaloid or alkaloid containing substance is caffeine. The aforementioned substances can be further comprised in any of the compositions, e.g., layers, of the multi-component delivery systems provided.

### Carrier Materials, Coatings and Flavoring Agents

It is to be understood that the multi-component oral delivery system can be formulated in any form suitable for oral delivery. In some embodiments, the multi-component oral delivery system is a tablet. In some embodiments, the multi-component oral delivery system is a capsule. In some embodiments, the multi-component oral delivery system comprises both a tablet component and a capsule component.

Carrier materials used in the multi-component oral delivery system can be substances customary for tablets, capsules, and coated tablets, etc. known in the art, for example: starch (e.g., maize starch), talc, microcrystalline cellulose, lactose, highly disperse silica, polyvinylpyrrolidone or cellulose powder. Other constituents of the tablet or capsule base (e.g., binders and disintegrants) which can also be employed are, for example, carbohydrates, such as mannitol, sorbitol, xylitol, glucose, sucrose, fructose, maltose, dextrose, maltodextrin, kaolin or cellulose derivatives such as methylcellulose, hydroxypropylcellulose or hydroxypropylmethylcellulose, as well as calcium carbonate, calcium, magnesium or glyceryl stearate and also colorants and flavorings. The proportionate composition of these base substances depends on the desired content of actual active substances, such as vitamins, minerals, bulk materials etc., and on the desired mechanicophysical properties of the tablet or capsule or of its layers, such as, for example, hardness, compressibility, size, shape, etc.

Furthermore, natural bulk materials, e.g., proteinaceous materials, can be present within the multi-component oral delivery system and are known in the art. Examples of natural bulk materials include, but are not limited to, finely ground soya, maize, wheat bran or alternatively crushed grain.

Any coating material that modifies the release of the components in the desired manner may be used, examples of which are provided herein or known in the art. In particular, coating materials suitable for use in the practice of the invention include, but are not limited to inert materials such as those that provide the desired release as provided herein. In some embodiments the inert material is an inert polymers, such as hydrogels and gel-forming materials and hydrophilic polymers. An inert polymer is any polymer that is chemically stable or does not interact chemically with other materials or components in the multi-component oral delivery system. Inert polymers include cellulose, cellulose acetate phthalate, cellulose acetate trimaletate, hydroxypropyl methylcellulose phthalate, polyvinyl acetate phthalate, amino methacrylate copolymers such as Eudragit® RS and RL, polyacrylic acid and polyacrylate and methacrylate copolymers such as Eudragit® S and L, polyvinyl acetaldiethylamino acetate, hydroxypropyl methylcellulose acetate succinate, and shellac. Hydrogels and gel-forming materials include carboxyvinyl polymers, sodium alginate, sodium carmellose, calcium carmellose, sodium carboxymethyl starch, polyvinyl alcohol, hydroxyethyl cellulose, methyl cellulose, gelatin, starch, and cellulose based cross-linked polymers in which the degree of crosslinking is low so as to facilitate adsorption of water and expansion of the polymer matrix, hydroxypropyl cellulose, hydroxypropyl methylcellulose, crosslinked starch, microcrystalline cellulose, chitin, aminoacryl-methacrylate copolymer (Eudragit® RS-PM), pullulan, collagen, casein, agar, gum arabic, sodium carboxymethyl cellulose, swellable hydrophilic polymers poly(hydroxyalkyl methacrylate) (molecular weight about 5 k-5,000 k), polyvinylpyrrolidone (molecular weight about 10 k-360 k), anionic and cationic hydrogels, polyvinyl alcohol having a low acetate residual, a swellable mixture of agar and carboxymethyl cellulose, copolymers of maleic anhydride and styrene, ethylene, propylene or isobutylene pectin (molecular weight about 30 k-300 k), polysaccharides such as agar, acacia, karaya, tragacanth, algins and guar, polyacrylamides, Polyox® polyethylene oxides (molecular weight about 100 k-5,000 k), AquaKeep® acrylate polymers, diesters of polyglucan, crosslinked polyvinyl alcohol and poly N-vinyl-2-pyrrolidone, and sodium starch glycolate (e.g., Explotab®). Hydrophilic polymers include polysaccharides, methyl cellulose, sodium or calcium carboxymethyl cellulose, hydroxypropyl methyl cellulose, hydroxypropyl cellulose, hydroxyethyl cellulose, nitrocellulose, carboxymethyl cellulose, cellulose ethers, polyethylene oxides (e.g. Polyox®, Union Carbide), methylethyl cellulose, ethylhydroxy ethylcellulose, cellulose acetate, cellulose butyrate, cellulose propionate, gelatin, collagen, starch, maltodextrin, pullulan, polyvinylpyrrolidone, polyvinyl alcohol, polyvinyl acetate, glycerol fatty acid esters, polyacrylamide, polyacrylic acid, copolymers of methacrylic acid or methacrylic acid (e.g., Eudragit®), other acrylic acid derivatives, sorbitan esters, natural gums, lecithins, pectin, alginates, ammonia alginate, sodium, calcium, potassium alginates, propylene glycol alginate, agar, and gums such as arabic, karaya, locust bean, tragacanth, carrageens, guar, xanthan, scleroglucan and mixtures and blends thereof.

In certain aspects of the invention, the multi-component oral delivery system is a system adapted to release vitamins, minerals, and/or other components (e.g., antioxidants, amino acids or electrolytes) to a subject at different locations within the body (e.g., oral cavity, stomach, intestine). Thus, the coating(s) may release or be adapted to release component(s) in a predetermined pattern (e.g., in order to achieve a controlled release formulation) or it may or may be adapted to retain (i.e., not release) the component(s) until after passage of the stomach (e.g., by using an enteric coating). Coatings that control release include, e.g. sugar coatings, film coatings (e.g., based on hydroxypropyl methylcellulose, cellulose, methylcellulose, methyl hydroxyethylcellulose, hydroxypropylcellulose, carboxymethylcellulose, folate, acrylate copolymers, polyethylene glycols and/or polyvinylpyrrolidone), and enteric coatings (e.g., based on a phthalate, methyl acrylate-methacrylic acid copolymer, methacrylic acid copolymer, cellulose acetate phthalate, hydroxypropyl methylcellulose phthalate, hydroxypropyl methylcellulose acetate succinate, cellulose acetate succinate, hypromellose acetate succinate, polyvinyl acetate phthalate (PVAP), shellac, sodium alginatem, stearic acid and/or ethylcellulose). An enteric coating is any coating that prevents release of components covered by or associated with the enteric coating until passage through the stomach and into the intestine.

Furthermore, a time delay material, such as, e.g., glyceryl monostearate or glyceryl distearate may be employed. Further, modified release matrix materials may also be used. Such materials are known to those skilled in the art. Modified release matrix materials suitable for the practice of the present invention include, but are not limited to, microcrystalline cellulose, sodium carboxymethylcellulose, hydroxyalkylcelluloses (e.g., hydroxypropylmethylcellulose and hydroxypropylcellulose), polyethylene oxide, alkylcelluloses (e.g., methylcellulose and ethylcellulose), polyethylene glycol, polyvinylpyrrolidone, cellulose acetate, cellulose acetate butyrate, cellulose acetate phthalate, cellulose acetate trimellitate, polyvinylacetate phthalate, polyalkylmethacrylates, polyvinyl acetate and mixtures thereof.

In some embodiments, the multi-component oral delivery system comprises a cellulose coating. In some embodiments, the multi-component oral delivery system comprises a Vitamin M (folate) coating. In some embodiments, the multi-component oral delivery system comprises an enteric coating, wherein the enteric coating comprises phthalates, methyl acrylate-methacrylic acid copolymers, cellulose acetate succinate (hypromellose acetate succinate), polyvinyl acetate phthalate (PVAP), sodium alginate and/or stearic acid. In some embodiments, the multi-component oral delivery system comprises a cellulose acetate phthalate coating. In some embodiments, the multi-component oral delivery system comprises a cellulose coating, a Vitamin M coating, and a cellulose acetate phthalate coating.

The multi-component oral delivery system may include a coating that protects or is adapted to protect composition or component(s) from unwanted chemical changes, (e.g., chemical degradation prior to the release of the active therapeutic substance). The coating may be applied as is known in the art (see, e.g., Remington: The Science and Practice of Pharmacy (20th ed.), ed. A. R. Gennaro, Lippincott Williams & Wilkins, 2000 and Encyclopedia of Pharmaceutical Technology, eds. J. Swarbrick and J. C. Boylan, 1988-1999, Marcel Dekker, New York).

As will be appreciated by the person skilled in the art, excipients such as plasticizers, lubricants, solvents and the like may be added to the coating. Suitable plasticizers include for example acetylated monoglycerides; butyl phthalyl butyl glycolate; dibutyl tartrate; diethyl phthalate; dimethyl phthalate; ethyl phthalyl ethyl glycolate; glycerin; propylene glycol; triacetin; citrate; tripropioin; diacetin; dibutyl phthalate; acetyl monoglyceride; polyethylene glycols; castor oil; triethyl citrate; polyhydric alcohols, glycerol, acetate esters, glycerol triacetate, acetyl triethyl citrate, dibenzyl phthalate, dihexyl phthalate, butyl octyl phthalate, diisononyl phthalate, butyl octyl phthalate, dioctyl azelate, epoxidized tallate, triisoctyl trimellitate, diethylhexyl phthalate, di-n-octyl phthalate, di-i-octyl phthalate, di-i-decyl phthalate, di-n-undecyl phthalate, di-n-tridecyl phthalate, tri-2-ethylhexyl trimellitate, di-2-ethylhexyl adipate, di-2-ethylhexyl sebacate, di-2-ethylhexyl azelate, and dibutyl sebacate.

In some embodiments, the multi-component oral delivery system further comprises a flavoring agent. A flavoring agent may include a sweetening agent, a food flavor, a fruit extract, or a natural or synthetic oil. The flavoring agents may be derived from synthetic flavor oils and/or oils derived from plants, leaves, flowers, fruits, and so forth, and combinations thereof. Representative flavor oils include peppermint oil, spearmint oil, cinnamon oil, and oil of wintergreen (methyl salicylate). Also useful are natural or synthetic fruit flavors, such as citrus oils including lemon, orange, grape, lime, and grapefruit, and fruit essences including apple, strawberry, cherry, pineapple and so forth. Other useful flavoring agents include menthol, chocolate, vanilla, bubblegum flavors, coffee flavors, liqueur flavors and combinations and the like. Flavoring agents and methods of incorporating flavoring agents are known in the art (see, e.g., U.S. Pat. Nos. 2,258,567, 2,369,847, 2,857,281, 3,832,473, and 4,569,852). In some embodiments, the flavoring agent is used to indicate when a subject should swallow the multi-component oral delivery system. In some embodiments, the flavoring agent is released and dissolves in the oral cavity. In some embodiments, dissolution of the flavoring agent results in the flavoring agent no longer being tasted (i.e., the flavor is no longer detected in the oral cavity) by the subject. In some embodiments, a subject is instructed to swallow the multi-component oral delivery system once the flavoring agent can no longer be tasted by the subject. In some embodiments, the flavoring agent is comprised in a first composition, such as a first layer.

### Time Delay and Lag Time

Methods for altering the release timing of an oral composition are provided herein or known in the art. As used herein, the term “time delay” denotes a duration of time between administration of the multi-component oral delivery of the present invention and the release of one or more components. The term “lag time” denotes the time between delivery of one or more components (e.g., vitamins, minerals, antioxidants, amino acids, and/or electrolytes) and the subsequent delivery of one or more other components (e.g., vitamins, minerals, antioxidants, amino acids, and/or electrolytes). In some embodiments, the component(s) and the other component(s) are the same type of component. In some embodiments, the component(s) and the other component(s) are different types of component. As described herein, “type of component” is used to define a class or group of components with similar characteristics or functions. Examples of types of components include vitamins (including vitamers), minerals, antioxidants, amino acids and derivatives thereof, and electrolytes. As an example, delivery of Vitamin C to the mouth and delivery of a B vitamin to the stomach would be considered delivery of the same type of component to two different locations with a lag time between delivery of Vitamin C and the B vitamin. As another example, delivery of Vitamin C to the mouth and delivery of glutathione to the stomach would be considered delivery of different types of components to two different locations with a lag time between delivery of Vitamin C and glutathione. An “identical component” is used to define a component that has the same characteristic or function. In some embodiments, the component(s) and other components(s) are not identical components. In other embodiments, the components(s) and other component(s) are identical components. As further examples, delivery of Vitamin C to the mouth and delivery of B vitamin to the stomach would be considered delivery of two components that are not identical to two different locations. Delivery of Vitamin C to the mouth and delivery of Vitamin C to the stomach would be considered delivery of an identical component to different locations.

It is also possible for the multi-component oral delivery system to combine various forms of release, which include, without limitation, immediate release, extended release, pulse release, variable release, controlled release, timed release, sustained release, delayed release, long acting, and combinations thereon. The ability to obtain immediate release, extended release, pulse release, variable release, controlled release, timed release, sustained release, delayed release, long acting characteristics and combinations thereof can be performed using known procedures and techniques. For example, the multi-component oral delivery system can comprise a component or components that is/are adapted to release in the oral cavity, stomach, and/or intestine with immediate release (e.g., within 10 minutes). In another example, the multi-component oral delivery system can comprise a component or components that is/are adapted to release in the oral cavity with immediate release (e.g., within 10 minutes), and released in the stomach and intestine with delayed release (e.g., after 1 hour).

The term “effective amount” or “amount effective to” is used herein to mean the amount of an agent, component, or compound required to perform a specific function, e.g. provide lag time or to provide a desired biological effect. The effective amount of active agent, component, or compound(s) used to practice the present invention can depend upon the active agent, component, or compound(s) as well as the composition of the multi-component oral delivery system. Ultimately, the skilled artisan will decide the appropriate amount.

The term “adapted to release” is used herein to mean that the multi-component oral delivery system or a portion of the multi-component delivery system, e.g., a composition or layer, comprises or is contained within appropriate carriers and/or coatings, etc. in an effective amount to release desired component(s) at a desired location (e.g., the stomach).

### Subjects

The term “subject” is intended to include animals, which are capable of performing physical activities, e.g., exercise. Examples of subjects include mammals, e.g., humans, dogs, cows, horses, pigs, sheep, goats, cats, mice, rabbits, and rats. In some embodiments, subjects include companion animals, e.g., dogs, cats, rabbits, and rats. In some embodiments, subjects include livestock, e.g., cows, pigs, sheep, goats, and rabbits. In some embodiments, subjects include thoroughbred or show animals, e.g., horses, pigs, cows, and rabbits. In certain embodiments, the subject is a human, e.g., a human that will perform physical activities, such as an athlete.

### Physical Activity

The term “physical activity” is intended to include any activity that requires use of muscles. In some embodiments, the physical activity is exercise. The term “exercise” as used herein includes any bodily activity that enhances or maintains physical fitness in a subject. Exercise can be aerobic exercise, e.g., cycling, swimming, walking, running, hiking, and sports such as tennis, basketball, rowing, and soccer. Exercise can be anaerobic exercise, e.g., weight training, sprinting, and high-intensity interval training. In aspects, the invention provides compositions and methods for use before and/or during physical activity. In some embodiments, the multi-component oral delivery system is administered to a subject before physical activity. In some embodiments, the multi-component oral delivery system is administered to a subject 5, 10, 15, 20, 25, 30, 35, 40, 45, 50, 55, 60, 90, 120 or more minutes before physical activity. In some embodiments, the multi-component oral delivery system is administered to a subject during physical activity. In some embodiments, the multi-component oral delivery system is administered to a subject 5, 10, 15, 20, 25, 30, 35, 40, 45, 50, 55, 60, 90, 120 or more minutes after the start of physical activity.

### Methods of Manufacturing

### Tablets

Methods for manufacturing tablets are provided herein or known in the art (see, e.g., U.S. Pat. Nos. 5,213,738, 5,853,760, 6,083,533, 6,270,798, 6,254,886, 6,960,356 and 7,521,067; Ausburger and Hoag. Pharmaceutical Dosage Forms: Tablets, Third Edition. Informa Healthcare, 2008 and Bender, David A. Nutritional Biochemistry of the Vitamins. Cambridge University Press, 1992, which are incorporated herein by reference in their entirety). Film coated tablets may be prepared by coating tablets using techniques such as rotating pan coating methods or air suspension methods to deposit a contiguous film layer on a tablet. Compressed tablets, for example, without limitation, may be prepared by mixing the components with excipients intended to add binding or disintegration qualities. The mixture can be either directly compressed, or granulated then compressed, using methods and machinery known to those in the industry. For example, the dry or pre-dried powder mixtures of carriers and auxiliaries (e.g., release agents) and active ingredients or components (e.g., vitamins, minerals, and/or amino acids) can be carefully layered one over the other in a commercially available tabletting machine (e.g., Cadmach® Tablet Presses) to form three layers. The powder layers layered one over the other in this way can then be finally compressed to give a multilayer tablet. The press pressure can be selected to be sufficient to form the tablet (e.g., between 50 and 120 Newtons) as known in the art.

Alternatively to this tabletting method, the individual layers can be pre-formed separately as is provided herein or known in the art (see, e.g., U.S. Pat. Nos. 5,853,760, 6,083,533, 6,270,798, and 6,254,886; Ausburger and Hoag. Pharmaceutical Dosage Forms: Tablets, Third Edition. Informa Healthcare, 2008 and Bender, David A. Nutritional Biochemistry of the Vitamins. Cambridge University Press, 1992). The layers pre-formed in this way can then be pressed at a sufficient press pressures (e.g., between 50 and 120 Newtons) to give the finished multilayer tablet. This pressing method has the advantage that the layers which have a different compressibility due to their different composition can be exposed to individual press pressures, which can be advantageous both with respect to the shelf life of the multilayer tablet as a whole and with respect to the stability of the active ingredients in the individual layers. In addition, the boundary layer between two layers in juxtaposition has a smaller active surface due to the preforming, whereby the possibility of the reaction or destabilization of sensitive active ingredients is reduced.

It is to be understood that the layers of the multi-component oral delivery system can have any geometry suitable for release at a specific time or location within the body, and it may be this geometry alone that adapts the compositions, such as the layers, for the desired release profile. For example, if the multi-component oral delivery system comprises layer, the layers may be stacked on top of each other, with or without spacers. In another example, the layers may be concentric such that the layer for release last (e.g., in the intestine) may be in the middle of the multilayer oral delivery system, the layer for release second (e.g., in the stomach) may surround the layer in the middle partially or entirely, and the layer for release first (e.g., in the oral cavity) may surround the middle and/or second layer partially or entirely. It is also to be understood that the term “first layer”, “second layer”, and “third layer” do not necessarily mean that the first layer is released first in time, the second layer is released second in time, and the third layer is released third in time.

In some embodiments, the multi-component oral delivery system is a tablet. In some embodiments, the multi-component oral delivery system is a tablet comprising three layers. In some embodiments, the multi-component oral delivery system is a tablet comprising: a) a first layer comprising at least one antioxidant, wherein the first layer is adapted to release in the oral cavity of a subject; b) a second layer comprising at least one electrolyte, wherein the second layer is adapted to release in the stomach of the subject; and c) a third layer comprising at least one vitamin and/or at least one amino acid, wherein the third layer is adapted to release in the intestine of the subject.

### Capsules

Methods for manufacturing capsules are included herein and known in the art (see, e.g., Mahato and Narang. Pharamceutical Dosage Forms and Drug Delivery, Second Edition. CRC Press 2011, Carstensen. Pharmaceutical Principles of Solid Dosage Forms, First Edition. Informa Healthcare 1993, U.S. Pat. Nos. 6,960,356, 7,635,490, 7,838,037, and 8,168,226, U.S. Pub. No. 20060246192, and Gandhi, R., Kaul, C. L. and Panchagnula, R., “Extrusion and spheronization in the development of oral controlled-release dosage forms” Pharm Sci Tech Today, 1999, 2, 160, which are incorporated herein in their entirety). Capsules can include hard-shelled capsules, which are normally used for dry, powdered ingredients or miniature pellets (also called beads, particules, granules or spheroids that are made by the process of Extrusion-Spheronization, micro-encapsulation, and/or fluidized bed coating (e.g., the Wurster fluid bed coating method)) or mini tablets. Extrusion-spheronization is a process known in the art of pharmaceuticals, to prepare spheres for pharmaceutical uses, including both conventional and controlled release dosage forms. Extrusion-spheronization can be a multiple process of wet mass extrusion followed by spheronization to produce uniform size spherical particles, referred to as spheroids, pellets, beads or matrix pellets depending upon the material as well as process used for extrusion-spheronization. The powder or spheroids inside the capsule may contain the active ingredient(s) (e.g., vitamins, minerals, or electrolytes) and any excipients, such as binders, disintegrants, fillers, glidant, and preservatives. Excipients for use in spheroids include microcrystalline cellulose and crystalline debranched starch. Release agents or coatings can also be included as described above. Capsules can be made from aqueous solutions of gelling agents such as gelatin, carrageenans, starch, and cellulose. Other ingredients can be added to the gelling agent solution like plasticizers such as glycerin and/or sorbitol to decrease the capsule's hardness, coloring agents, preservatives, disintegrants, lubricants and surface treatment. The process of encapsulation of hard gelatin capsules can be done on manual, semi-automatic and automatic machines. Capsules can include soft-shelled capsules, primarily used for oils and for active ingredients that are dissolved or suspended in oil. Softgels can be filled at the same time as they are produced and sealed on the rotary die of a fully automatic machine. It is to be understood that capsules can comprise powders, spheroids, pellets, mini-tablets, gels, liquids, and any combination thereof.

In some embodiments, the multi-component oral delivery system is a capsule comprising spheroids adapted to release in different locations in the body. In some embodiments, the capsule comprises three populations of spheroids: a) spheroids adapted to release in the oral cavity; b) spheroids adapted to release in the stomach; and c) spheroids adapted to release in the intestine.

In some embodiments, the multi-component oral delivery system is a multilayer capsule. In some embodiments, the multilayer capsule comprises three layers. In some embodiments, the multilayer capsule comprises: a) a layer adapted to release in the oral cavity; b) a layer adapted to release in the stomach; and c) a layer adapted to release in the intestine. In some embodiments, each layer is a powder. In some embodiments, each layer is a gel. In some embodiments, each layer is a liquid. In some embodiments, the multilayer capsule may comprise powder layers and gel layers. In some embodiments, the multilayer capsule comprises powder layers and liquid layers. In some embodiments, the multilayer capsule comprises gel layers and liquid layers. In some embodiments, the layers are separated by at least one coating. In some embodiments the at least one coating results in or is adapted to result in release of a component or component(s) at a desired location. In some embodiments, the multilayer capsule comprises: a) a layer adapted to release in the oral cavity; b) a layer adapted to release in the stomach; and c) a layer adapted to release in the intestine, wherein the layers are adapted for the desired release by being separated by at least one coating.

In some embodiments, the multi-component oral delivery system can be a combination of a tablet and a capsule. In some embodiments, the multi-component oral delivery system comprises three layers, wherein each layer is a tablet or a capsule layer. For example, the layer adapted to release in the intestine may be a capsule layer, and the layers adapted to release in the stomach and oral cavity may be in tablet form and surround the capsule. Alternatively, the layer adapted to release in the intestine and the layer adapted to release in the stomach may be a tablet layer, and the layer adapted to release in the oral cavity may be a capsule layer.

### Kits

In some aspects, the invention provides a kit comprising a multi-component oral delivery system, and a storage container. The kit may further comprise instructions. The storage container may be a bottle, foil packaging, box, or any other storage container known in the art. The storage container can be made of any material (e.g., a plastic, glass, cardboard, metal, or any combination thereof). The instructions may be in the form of a label on the storage container, or may be a separate insert.

The following examples illustrate the invention, without at the same time wishing to restrict it.

### EXAMPLES

### Example 1

### A Multilayer Tablet

A three-layer tablet is produced by using a commercially available tablet press. A first layer for release in the oral cavity consisting of Vitamin A, Vitamin C, and Vitamin E plus a filler such as cellulose and a flavoring agent such as a fruit flavor are introduced into the press and pressed using 40 Newtons press pressure to form the first component of the tablet. A second layer for release in the stomach consisting of sodium chloride and potassium chloride plus a filler such as cellulose and a release agent or a coating such as Vitamin M are introduced into the press and pressed using 40 Newtons press pressure to form a second component of the tablet. A third layer for release in the intestine consisting of glutathione, amino acids, Vitamin B₁, Vitamin B₆, and Vitamin B₁₂, or vitamers thereof, plus a filler such as a cellulose and a release agent or a coating such as cellulose acetate phthalate are introduced into the press and pressed using 40 Newtons press pressure to form a third component of the tablet. The three components of the tablet are then pressed together using 100 Newtons press pressure to produce a single three-layer tablet.

Alternatively, the three layers can be introduced into the commercially available tablet press without first preforming the individual layers. Compression is carried out to form all three layers using a press pressure of 110 Newtons, producing a three-layer tablet.

### Example 2

### A Multilayer Capsule

A three-layer capsule, comprising three powders containing components separated from each other by three hard capsule shells is produced by using a commercially available capsule maker, e.g., a capsule filling machine. A first powder containing components for release in the intestine consisting of glutathione, amino acids, Vitamin B₁, Vitamin B₆, and Vitamin B₁₂, or vitamers thereof, plus a filler such as a cellulose are introduced into a first hard capsule shell, wherein the shell contains a release agent or a coating such as cellulose acetate phthalate. A second powder for release in the stomach consisting of sodium chloride and potassium chloride plus a filler such as cellulose and the first hard capsule shell containing the first powder are introduced into a second hard capsule shell, wherein the shell contains a release agent or a coating such as Vitamin M (folate). A third powder for release in the oral cavity consisting of Vitamin A, Vitamin C, and Vitamin E plus a filler such as cellulose and a flavoring agent such as a fruit flavor and the second hard capsule containing the second powder and the first hard capsule are introduced into a third hard capsule shell, wherein the shell contains a release agent or a coating such as cellulose.

### Example 3

### A Multi-Component Capsule

A first dry blend of cellulose and/or unbranched starch and Vitamin A, Vitamin C, and Vitamin E is wet massed with water in a planetary mixer for 10 minutes. Wet mass is then extruded by means of a dome screw extruder through a extrusion screen with a 1 mm die opening and an extrusion speed of 50 rpm. Extruded wet mass is then spheronized at speed of 850 rpm for 2 minutes and 30 seconds. Obtained wet spheroids are dried in a fluidized bed at inlet air temperature of 60° C. until the constant weight of the material is obtained, producing a first set of spheroids for release in the oral cavity.

A second dry blend of cellulose and/or unbranched starch and sodium chloride and potassium chloride plus a release agent or a coating such as Vitamin M is wet massed with water in a planetary mixer for 10 minutes. Wet mass is then extruded by means of a dome screw extruder through a extrusion screen with a 1 mm die opening and an extrusion speed of 50 rpm. Extruded wet mass is then spheronized at speed of 850 rpm for 2 minutes and 30 seconds. Obtained wet spheroids are dried in a fluidized bed at inlet air temperature of 60° C. until the constant weight of the material is obtained, producing a second set of spheroids for release in the stomach.

A third dry of cellulose and/or unbranched starch and glutathione, amino acids, Vitamin B₁, Vitamin B₆, and Vitamin B₁₂, or vitamers thereof, plus a release agent or a coating such as an enteric coating is wet massed with water in a planetary mixer for 10 minutes. Wet mass is then extruded by means of a dome screw extruder through a extrusion screen with a 1 mm die opening and an extrusion speed of 50 rpm. Extruded wet mass is then spheronized at speed of 850 rpm for 2 minutes and 30 seconds. Obtained wet spheroids are dried in a fluidized bed at inlet air temperature of 60° C. until the constant weight of the material is obtained, producing a third set of spheroids for release in the intestine.

The first, second, and third set of spheroids are then placed into a capsule, e.g., a gelatin or cellulose capsule, that can be dissolved orally.

### SCOPE AND EQUIVALENTS

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all methods, reagents, and configurations described herein are meant to be exemplary and that the actual methods, reagents, and configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the embodiments described herein are presented by way of example only and that, within the scope of the appended claims and equivalents thereto, the invention may be practiced otherwise than as specifically described and claimed. The present invention is directed to each individual feature, system, article, material, reagent, kit, and/or method described herein. In addition, any combination of two or more such features, systems, articles, materials, kits, and/or methods, if such features, systems, articles, materials, reagents, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an”, as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B”, when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of”, when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently, “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

It should also be understood that, unless clearly indicated to the contrary, in any methods claimed herein that include more than one act, the order of the acts of the method is not necessarily limited to the order in which the acts of the method are recited.

It should further be understood that the citation of any reference herein is not an admission that the reference is prior art.

What is claimed is:

1. A multi-component oral delivery system comprising:
a) a first composition comprising at least one antioxidant, wherein the first composition is adapted to release the at least one antioxidant in the oral cavity of a subject;
b) a second composition comprising at least one electrolyte, wherein the second composition is adapted to release the at least one electrolyte in the stomach of the subject; and
c) a third composition comprising at least one vitamin and/or at least one amino acid, wherein the third composition is adapted to release the at least one vitamin and/or at least one amino acid in the intestine of the subject.

2. The multi-component oral delivery system of claim 1, wherein the multi-component oral delivery system comprises a first layer, a second layer and a third layer, and wherein the first layer comprises the first composition, the second layer comprises the second composition and the third layer comprises the third composition.

3. The multi-component oral delivery system of claim 1, wherein the at least one antioxidant is Vitamin A, Vitamin C, Vitamin E, glutathione, a proanthocyanidin, a curcumin, a resveratrol, a flavonoid, Coenzyme Q10, Selenium, Zinc, epigallocatechin gallate, a withanolide, a polyphenol or a carotenoid.

4. The multi-component oral delivery system of claim 1, wherein the at least one electrolyte is chloride, potassium, sodium, magnesium, calcium, bicarbonate, sulfate, hydrogen phosphate, phosphate, or a salt thereof.

5. The multi-component oral delivery system of claim 1, wherein the at least one vitamin is Vitamin A, a B vitamin, Vitamin C, Vitamin D, Vitamin E, Vitamin K, Vitamin M, or a vitamer thereof.

6. The multi-component oral delivery system of claim 5, wherein the at least one vitamin is a B vitamin.

7. The multi-component oral delivery system of claim 6, wherein the B vitamin is B₁, B₂, B₃, B₅, B₆, B₇, B₉, or B₁₂.

8. The multi-component oral delivery system of claim 1, wherein the at least one amino acid is selected from the group consisting of: alanine, arginine, aspartic acid, glutamic acid, glycine, histidine, isoleucine, leucine, lysine, methionine, phenylalanine, proline, serine, threonine, tyrosine, valine, tryptophan, cysteine, and glutamine.

9. The multi-component oral delivery system of claim 1, wherein the second composition further comprises at least one vitamin or at least one mineral.

10. The multi-component oral delivery system of claim 9, wherein the at least one vitamin of the second composition is Vitamin A, a B vitamin, Vitamin C, Vitamin D, Vitamin E, or Vitamin K, or a vitamer thereof.

11. The multi-component oral delivery system of claim 9, wherein the at least one mineral of the second composition is Boron, Calcium, Chlorine, Chromium, Cobalt, Copper, Fluorine, Iodine, Iron, Magnesium, Manganese, Molybdenum, Nickel, Phosphorus, Potassium, Selenium, Sodium, Sulfur, Vanadium, Zinc or a salt form thereof.

12. The multi-component oral delivery system of claim 1, wherein the third composition further comprises glutathione.

13. The multi-component oral delivery system of claim 1, wherein the first composition comprises Vitamin A, Vitamin C, and Vitamin E; the second composition comprises an electrolyte; and the third composition comprises glutathione, an amino acid, Vitamin B₁, Vitamin B₆, and Vitamin B₁₂.

14. The multi-component oral delivery system of claim 13, wherein Vitamin A is present in an amount of 500 micrograms to 3000 micrograms, Vitamin C is present in an amount of 50 milligrams to 2000 milligrams, Vitamin E is present in an amount of 10 milligrams to 1000 milligrams, Vitamin B₁ is present in an amount of 1 milligram to 100 milligrams, Vitamin B₆ is present in an amount of 1 milligram to 100 milligrams, Vitamin B₁₂ is present in an amount of 2 micrograms to 2000 micrograms, and glutathione is present in an amount of 50 mg to 600 mg.

15. The multi-component oral delivery system of claim 1, wherein the first composition further comprises a flavoring agent.

16-36. (canceled)

37. A method of manufacturing a multi-component oral delivery system, comprising:
a) preparing or obtaining a first composition comprising at least one antioxidant, wherein the first composition is adapted to release the at least one antioxidant in the oral cavity of a subject;
b) preparing or obtaining a second composition comprising at least one electrolyte, wherein the second composition is adapted to release the at least one electrolyte in the stomach of the subject;
c) preparing or obtaining a third composition comprising at least one vitamin and/or at least one amino acid, wherein the third composition is adapted to release the at least one vitamin and/or at least one amino acid in the intestine of the subject; and
d) combining the first, second, and third compositions to produce a multi-component delivery system.

38-39. (canceled)

40. A method of manufacturing a multi-component oral delivery system, comprising:
a) preparing or obtaining a first composition comprising at least one antioxidant, wherein the first composition is adapted to release the at least one antioxidant in the oral cavity of a subject;
b) compressing the first composition to form a first layer;
c) preparing or obtaining a second composition comprising at least one electrolyte, wherein the second composition is adapted to release the at least one electrolyte in the stomach of the subject;
d) compressing the second composition to form a second layer;
e) preparing or obtaining a third composition comprising at least one vitamin and/or at least one amino acid, wherein the third composition is adapted to release the at least one vitamin and/or at least one amino acid in the intestine of the subject;
f) compressing the third composition to form a third layer; and
g) compressing the first, second, and third layers to provide a multi-component oral delivery system.

41. A method of manufacturing a multi-component oral delivery system, comprising:
a) preparing or obtaining a first dry composition comprising at least one antioxidant, wherein the first dry composition is adapted to release in the oral cavity of a subject;
b) wet massing the first dry composition to produce a first wet mass;
c) extruding the first wet mass to produce a first extruded wet mass;
d) spheronizing the first extruded wet mass to obtain a first set of wet spheroids;
e) drying the first set of wet spheroids to obtain a first set of spheroids;
f) preparing or obtaining a second dry composition comprising at least one electrolyte, wherein the second dry composition is adapted to release the at least one electrolyte in the stomach of the subject;
g) wet massing the second dry composition to produce a second wet mass;
h) extruding the second wet mass to produce a second extruded wet mass;
i) spheronizing the second extruded wet mass to obtain a second set of wet spheroids;
j) drying the second set of wet spheroids to obtain a second set of spheroids;
k) preparing or obtaining a third dry composition comprising at least one vitamin and/or at least one amino acid, wherein the third dry composition is adapted to release the at least one vitamin and/or at least one amino acid in the intestine of the subject;
l) wet massing the third dry composition to produce a third wet mass;
m) extruding the third wet mass to produce a third extruded wet mass;
n) spheronizing the third extruded wet mass to obtain a third set of wet spheroids;
o) drying the third set of wet spheroids to obtain a third set of spheroids; and
p) combining the first, second, and third set of spheroids to produce a multi-component oral delivery system.

42. A method of manufacturing a multi-component oral delivery system, comprising:
a) preparing or obtaining a first dry composition comprising at least one antioxidant;
b) wet massing the first dry composition to produce a first wet mass;
c) extruding the first wet mass to produce a first extruded wet mass;
d) spheronizing the first extruded wet mass to obtain a first set of wet spheroids;
e) drying the first set of wet spheroids to obtain a first set of spheroids;
f) adapting the first set of spheroids to release the at least one antioxidant in the oral cavity of a subject;
g) preparing or obtaining a second dry composition comprising at least one electrolyte;
h) wet massing the second dry composition to produce a second wet mass;
i) extruding the second wet mass to produce a second extruded wet mass;
j) spheronizing the second extruded wet mass to obtain a second set of wet spheroids;
k) drying the second set of wet spheroids to obtain a second set of spheroids;
l) adapting the second set of spheroids to release the at least one electrolyte in the stomach of the subject;
m) preparing or obtaining a third dry composition comprising at least one vitamin and/or at least one amino acid;
n) wet massing the third dry composition to produce a third wet mass;
o) extruding the third wet mass to produce a third extruded wet mass;
p) spheronizing the third extruded wet mass to obtain a third set of wet spheroids;
q) drying the third set of wet spheroids to obtain a third set of spheroids;
r) adapting the third set of spheroids to release the at least one vitamin and/or at least one amino acid in the intestine of the subject; and
s) combining the first, second, and third set of spheroids to produce a multi-component oral delivery system.

43-44. (canceled)

45. A kit, comprising:
a) the multi-component oral delivery system of claim 1;
b) a storage container; and
c) instructions.

46-47. (canceled)
